(19) United States
(12) Patent Application Publication
(10) Pub. No.: US 2016/0035204 A1
(43) Pub. Date: Feb. 4, 2016

(54) SYSTEM AND METHOD FOR IMPROVING OUTDOOR SAFETY

(71) Applicant: Ryan M. Jansen, Bedford, MA (US)

(72) Inventor: Ryan M. Jansen, Bedford, MA (US)

(21) Appl. No.: 14/813,631

(22) Filed: Jul. 30, 2015

Related U.S. Application Data
(60) Provisional application No. 62/031,133, filed on Jul. 30, 2014.

(51) Int. Cl. G08B 21/02; H04W 4/02

(52) U.S. Cl. CPC G08B 21/02; H04W 4/02

(57) ABSTRACT

At least one computer-readable storage medium encoded with executable instructions that, when executed by a first device, cause the first device to carry out a method that improves outdoor safety by optionally tracking the geographic location of a first device and, when a criterion for automatic emergency notification set at the first device is satisfied, transmitting a notification of an emergency to another device. The method may comprise in response to determining that tracking of a geographic location of the first device is enabled: determining a geographic location of the first device, and transmitting the geographic location of the first device to a second device; and in response to determining that a criterion for automatic emergency notification is satisfied, transmitting a notification of an emergency for a user to a third device different from the second device.

### RELATED APPLICATIONS

This application claims the benefit under 35 U.S.C. §119(e) of U.S. Provisional Patent Application Ser. No. 62/031,133, filed on Jul. 30, 2014 and entitled “SYSTEM AND METHOD FOR IMPROVING OUTDOOR SAFETY,” which is hereby incorporated herein by reference in its entirety.

### BACKGROUND

People enjoy going and being outdoors. Unfortunately, unexpected emergencies arise—a person may get lost or separated from a group, someone may fall and get injured, or inclement weather may arrive without notice and trap a person or group.

### SUMMARY

Some aspects include at least one computer-readable storage medium encoded with executable instructions that, when executed by a first device, cause the first device to carry out a method. The method may comprise in response to determining that tracking of a geographic location of the first device is enabled: determining a geographic location of the first device, and transmitting the geographic location of the first device to a second device; and in response to determining that a criterion for automatic emergency notification is satisfied, transmitting a notification of an emergency for a user to a third device different from the second device.

Further aspects include at least one computer-readable storage medium encoded with executable instructions that, when executed by at least one processor, cause the at least one processor to carry out a method. The method may comprise receiving, from a first device, a geographic location of the first device; storing a history of geographic locations of the first device; and in response to determining that a criterion for automatic emergency notification is satisfied, transmitting a notification of an emergency for a user of the first device to a second device.

Additional aspects include at least one computer-readable storage medium encoded with executable instructions that, when executed by at least one processor, cause the at least one processor to carry out a method. The method may comprise receiving, from a first device and/or a second device, a notification of an emergency for a user of the first device; and in response to receiving the notification: displaying information about the first device and/or the user based on the notification; and scanning for a signal from the first device.

The foregoing is a non-limiting summary of the application. It should be appreciated that the acts described and claimed herein may be used in other combinations, even if not expressly recited in those combinations the attached claims. In particular, acts recited in two or more dependent claims may be used together in a system or method for improving outdoor safety without the acts recited in the independent claims from which those claims depend.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an exemplary system with which some embodiments may operate;

FIGS. 2A and 2B are flowcharts of an exemplary process for automatically sending an emergency notification that may be used in some embodiments;

FIG. 3 is a flowchart of an exemplary server-side process for automatically sending an emergency notification that may be used in some embodiments;

FIG. 4 is a flowchart of an exemplary local process that may be used in some embodiments;

FIG. 5 is a flowchart of an exemplary breadcrumb trail process that may be used in some embodiments; and

FIG. 6 illustrates an example of a computing system environment with which some embodiments may operate.

### DETAILED DESCRIPTION

Embodiments of the present application may improve outdoor safety by optionally tracking the geographic location of a first device at a server and, when a criterion (which may also be referred to as condition(s)) for automatic emergency notification set by a first user of the first device is satisfied, transmitting a notification of an emergency (also referred to herein as an emergency notification) for the first user to at least one second device. The second device may be associated with and/or operated by a person who is an emergency contact designated by the user. The second device may additionally or alternatively be a device operated by another user that happens to be near the first device and within range to receive an emergency notification broadcast by the first device. The first device may transmit the notification via signals such as Bluetooth Low Energy beacons or other signals transmitted according to a wireless personal area network (WPAN) protocol, or any other protocol with a transmission range of less than 100 meters or less than 10 meters. In some embodiments, a breadcrumb trail representing the recent history of locations of the device may be stored on the first device, the server, and/or an additional device and displayed to the first user and/or a potential rescue party.

The inventor has recognized and appreciated that a system or method for automatically sending an emergency notification may overcome the disadvantages of traditional approaches to improving outdoor safety. Without such a system or method aiding the provision of timely assistance, a person or group facing an emergency outdoors may be at serious risk of injury or death. Reducing the amount of time needed for a person to obtain assistance when facing an emergency outdoors may improve the person's safety. Approaches for improving outdoor safety when facing an emergency traditionally have required a person to be able to perform certain actions, such as lighting a fire, discharging a firearm, or even making a telephone call. The inventor has recognized and appreciated that such approaches may not be possible for every person or in every situation. For example, a person may not have the requisite expertise or resources to light a fire or discharge a firearm, and a person may not be able to operate a telephone whether due to temporary or permanent disability, injury, unconsciousness, or any other reason.

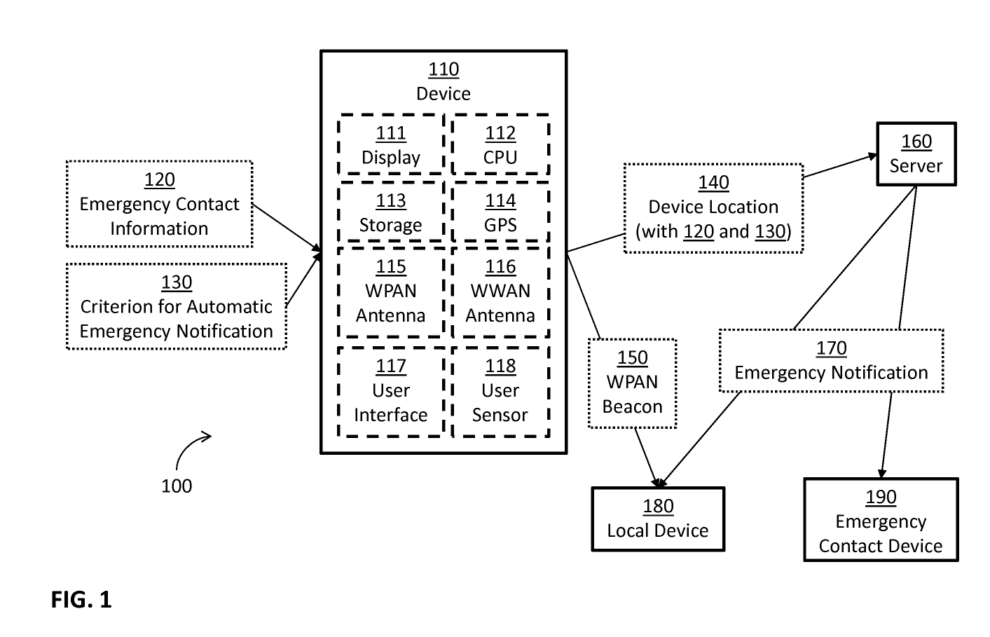

Referring initially to FIG. 1, a block diagram of an exemplary system 100 with which some embodiments may operate is illustrated therein. According to some embodiments, device 110 may be a mobile device carried or worn by a user, such as a smartphone, a smart watch, or any other suitable device, though embodiments are not limited to operating with any particular type of device. Device 110 may include a display 111, a CPU 112, storage 113, a global positioning system (GPS) module 114, a WPAN antenna 115 (e.g., a Bluetooth Low Energy, Z-Wave, or any other suitable antenna), a wireless wide area network (WWAN) antenna 116 (e.g., a cellular network antenna), a user interface 117, and/or a user sensor 118. A user may operate the device 110 through the user interface 117, while the user sensor 118 may measure characteristics (such as biometric characteristics) relating to the user, including but not limited to when the user wears the device 110. The user interface 117 may include a graphical user interface (GUI), a speech- or audio-controlled interface, a collection of buttons or other tactile mechanisms, a touch screen or pad, and/or any other suitable interface, as embodiments are not limited in this respect.

According to some embodiments, the device 110 may receive input from a user through the user interface 117. The user may input emergency contact information 120. Emergency contact information 120 may include information sufficient to establish communication with or transmit a communication to one or more contacts the user wants to notify when or if the user experiences an emergency. For example, emergency contact information 120 may include a name or title, a telephone number for voice dialing, a telephone number for short messaging service (SMS) communication, and/or an e-mail address for a person or organization. The user may input emergency contact information 120 in any suitable manner, including by manually entering the information or selecting a contact from a contact list stored on the device 110 (for example, in storage 113).

According to some embodiments, the user may also input through the user interface 170 a criterion for automatic emergency notification 130. The criterion 130 may be used to regulate whether automatic emergency notification will be transmitted. This criterion may relate to one or more values of one or more variables. The values may be classified as any suitable data type or types, including a Boolean, an integer, a floating-point number, an alphanumeric string, and/or a character. The variables may relate to reception of a trigger, location, time, and/or any other suitable information.

For example, the criterion 130 may be that the device 110 receives an emergency notification trigger from the user. In this example, the variable may be the reception of the emergency notification trigger from the user, and if the value is positive (e.g., represented by “>0,” “true,” “1,” or any other suitable representation), the criterion 130 may be satisfied and so an automatic emergency notification will be transmitted.

The criterion for automatic emergency notification 130 may alternatively or additionally depend on the device location 140, which may be determined by the GPS module 114 of the device 110. The criterion 130 may be that the device 110 and/or a server 160 does not receive (e.g., from the GPS 114 or the WWAN antenna 116) a device location 140 that has changed sufficiently relative to one or more previous device locations (not shown) for a designated interval of time. For example, if the device location 140 does not change at all for 3 hours, the user may be lost, injured, ill, involuntarily disabled, unconsciousness, trapped by inclement weather, or experiencing any other emergency, and so such a criterion for automatic emergency notification 130 may be appropriate. In this example, the variable may have a value indicating whether a device location 140 has changed sufficiently (e.g., more than a threshold distance) relative to one or more previous device locations for a designated interval of time. A definition of a sufficient change may originate from receiving a threshold value or values from a user or device, including the threshold value or values in memory during manufacture or preparation, or any other suitable source. If the variable's value is null or “negative” (e.g., represented by “<1,” “false,” “0,” or any other suitable representation), the criterion 130 may be satisfied and so automatic emergency notification may occur.

Alternatively or additionally, the variable may have a value indicating the aggregate change calculated (e.g., by CPU 112, by server 160, by local device 180, and/or by any other suitable device) between the coordinates of the device location 140 and of all previous device locations received within 3 hours of the device location 140. The variable's value may indicate the coordinates resulting from that calculation (e.g., represented by degrees of arc, minutes of arc, seconds of arc, and/or any other suitable representation). If the variable's value is less than a threshold (e.g., 1 second of arc), the criterion 130 may be satisfied and so automatic emergency notification may occur.

Alternatively or additionally, the variable may have a value indicating the interval of time elapsed since a device (e.g., the server 160) received the last device location 140 (calculated by the server 160, for example). The variable's value may indicate the time resulting from that calculation (e.g., represented by seconds, minutes, hours, and/or any other suitable representation). If the variable's value is greater than a threshold (e.g., 3 hours), the criterion 130 may be satisfied and so automatic emergency notification may occur.

Alternatively or additionally, the criterion for automatic emergency notification 130 may be that the device 110 and/or server 160 does not receive, within a designated interval of time or by a designated time, a device location 140 within a designated area (the designated time and/or area may originate from receiving a value or values from a user or device, including the value or values in memory during manufacture or preparation, or any other suitable source). For example, if the device location 140 does not fall within the area of a user's destination within a certain interval or by a certain time, the user may be lost, injured, ill, involuntarily disabled, unconsciousness, trapped by inclement weather, or experiencing any other emergency, and so an automatic emergency notification 130 may be appropriate. In this example, the variable have a value indicating whether, within a designated interval of time or by a designated time, a device location 140 is within a designated area. If the value is null or “negative” (e.g., represented by “<1,” “false,” “0,” or any other suitable representation), the criterion 130 may be satisfied and so automatic emergency notification may occur.

Alternatively, a first variable may be the difference calculated (e.g., by CPU 112, by server 160, by local device 180, and/or by any other suitable device) between the coordinates of the most recent device location 140 and of the center or boundary of the designated area. The value of the first variable may be the coordinates resulting from that calculation (e.g., represented by degrees of arc, minutes of arc, seconds of arc, and/or any other suitable representation). A second variable may be the current time, with a value that may be compared to the designated time. If the value of the first variable is greater than a designated maximum (e.g., 2 seconds of arc) and the value of the second variable is greater than the designated time, the criterion 130 may be satisfied and so automatic emergency notification may occur.

The criterion for automatic emergency notification 130 may alternatively or additionally depend on one or more biometric characteristics of the user, which the user sensor 118 of the device 110 may measure and/or determine. According to some embodiments, the criterion 130 may be that the heart rate, blood pressure, body temperature, brain activity, and/or any other characteristic of the user at that time and/or at present is outside a range considered healthy and/or safe. In some embodiments, the device 110 may receive input from the user that enables or disables measuring, tracking, and using biometric characteristics as the criterion 130. Additionally, the device 110 may receive a range from the user for any such characteristic, as a healthy/safe range may be different between different users, especially for heart rate. For example, a typical healthy range for a heart rate may be between about 60 and 100 beats per minute, while a healthy range for a person who frequently exercises may be as low as about 40 beats per minute.

According to some embodiments, the device 110 may receive an upper and/or lower threshold value of the range for any such characteristic(s) from the user. For example, the device 110 may receive a lower threshold heart beat value of 40 beats per minute and/or an upper threshold heart beat value of 120 beats per minute. On the other hand, the device 110 may rely on a standard range (e.g., a range stored in memory during manufacture or preparation of the device 110 and/or the server 160) for characteristics. For example, it is generally standardized that a body temperature above about 100 degrees Fahrenheit may be indicative of a fever, a body temperate above about 103 degrees Fahrenheit may indicate the need for medical treatment, a body temperature below about 96 or 97 degrees Fahrenheit may indicate the beginning of freezing, and a body temperature below about 95 degrees Fahrenheit may indicate hypothermia and extreme danger. It should be appreciated that there may be multiple different thresholds, and the device 110 may react differently to the different thresholds (e.g., reacting to some thresholds as indicating an emergency and to others as indicating normality or reacting to some thresholds as indicating more of an emergency than others).

According to some embodiments, the device 110 may determine whether the user sensor 118 is present and can support detecting, measuring, and/or otherwise determining given biometric characteristics. If the user sensor 118 is not present or cannot detect, measure, and/or otherwise determine the biometric characteristics, the device 110 may disable any features dependent on the biometric characteristics. The inventor has recognized and appreciated that automatically disabling such features may preserve power and battery life, which can be especially important in outdoor emergency situations.

When the user has enabled automatic location tracking of the device, the device location 140 may be transmitted by the device 110 (for example, via the WWAN antenna 116) to the server 160 at regular intervals (e.g., every 10 seconds of time). The device 110 may also transmit the emergency contact information 120 and the criterion for automatic emergency notification 130 to the server 160, each of which may be transmitted with the other and/or the device location 140 or separately. The server 160 may be a centralized or distributed server capable of communicating via any suitable means, such as a WWAN, a telecommunication network, and/or the Internet.

Should the device 110 and/or the server 160 determine that the criterion for automatic emergency notification 130 is satisfied (by determining that the value(s) of the variable(s) of the criterion 130 is/are satisfied), the server 160 may transmit an emergency notification 170 to a local device 180 and/or an emergency contact device 190. The emergency notification 170 may be a notification of an emergency that the user of the device 110 may be experiencing or may have experienced, such as those described above or any other suitable situation. The emergency notification 170 may take the form of a voice telephone call, a SMS, an e-mail, a push notification, and/or any other suitable communication. The emergency experienced by the user of the device 110 may include the user becoming lost or separated from a group, falling, getting injured, becoming ill, becoming involuntarily disabled (temporarily or permanently), fainting or otherwise becoming unconsciousness involuntarily, being trapped by inclement weather, and/or any other suitable experience.

The emergency notification 170 may include information relating to the device 110 and/or the user of the device 110. For example, this information may include the device location 140; the time at which the most recent device location 140 was received by the server 160; the weather near the device location 140 at that time, at present, and/or in the near future; a characteristic of the user such as biometric information including heart rate, blood pressure, body temperature, brain activity, and/or any other characteristic at that time and/or at present (any of which may be measured by the user sensor 118) if supported by the user sensor 118; the criterion for automatic emergency notification 130 used; and/or any other suitable information.

The local device 180 may be a device similar to the device 110 and within range of WPAN communication (e.g., Bluetooth or any other suitable short-range communication) from the device 110. The local device 180 being within this range of the device 110 may advantageous for a number of reasons. For example, the local device 180 may be used by a person or group near the user of the device 110 (e.g., in the same hiking, climbing, or other outdoor activity area) who may be able to search for, find, and/or help the user, any of which being within this range may enable. The local device 180 may also be able to receive WPAN communications such as a WPAN beacon 150 from the device 110 (should the device 110 and/or the server 160 determine that the criterion for automatic emergency notification 130 is satisfied) by being within this range. Detection of the WPAN beacon 150 may increase the probability that a user of the local device 180 will find the device 110 and hopefully the user experiencing an emergency. The WPAN beacon 150 may be a signal emitted via Bluetooth Low Energy, which may transmit information for longer intervals of time than other forms of communication given the same amount of battery power.

The server 160 may select the local device 180 based on its proximity to the device 110. For example, the server 160 may select the nearest suitable device to the device 110 (or multiple suitable devices within a designated distance) as the local device 180. The server 160 may also broadcast the emergency notification 170 to any suitable devices based on some information such as signal strength in a given area. By broadcasting, especially to an area with sufficient signal strength, the server 160 may increase the probability that someone will receive the emergency notification 170 and assist the user of the device 110.

The emergency contact device 190 may represent any device through which the emergency contact or contacts selected by the user may receive one of the forms of communication entered by the user. For example, the emergency contact device 190 may be a smartphone, a tablet, a laptop computer, a desktop computer, and/or any other suitable device.

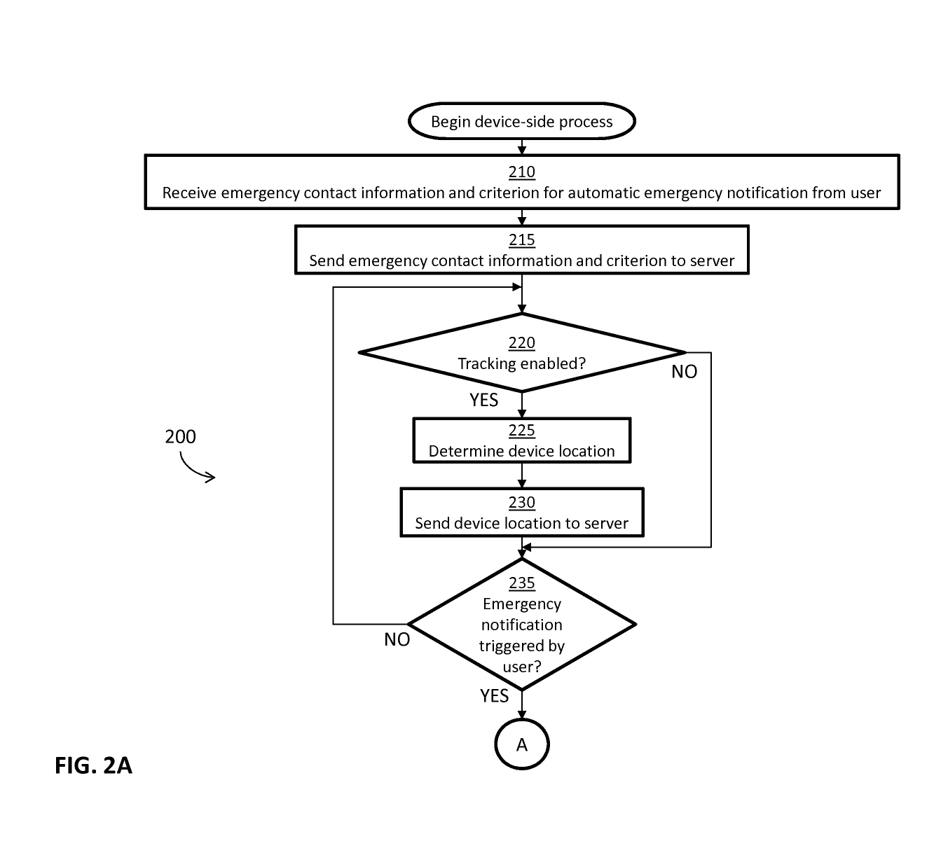

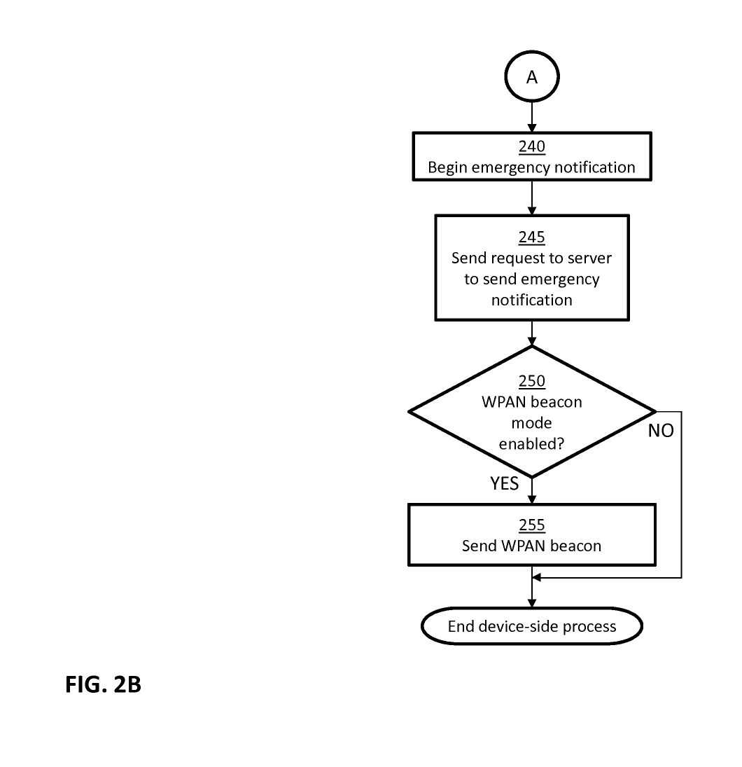

FIGS. 2A and 2B illustrate flowcharts of an exemplary process 200 for automatically sending an emergency notification that may be used in some embodiments. Before the process 200 begins, a user may install on the device (which may correspond to the device 110 described above) and configure an emergency notification utility through which embodiments of the present application may operate. The process 200 begins at stage 210. At stage 210, the emergency notification utility may receive from the user emergency contact information and at least one criterion for automatic emergency notification (which may correspond to the criterion for automatic emergency notification 130 above). At stage 215, the emergency notification utility may transmit the emergency contact information and the at least one criterion for automatic emergency notification to a server (which may correspond to the server 160 described above) via the WWAN antenna (which may correspond to the WWAN antenna 116 described above) or any other suitable component.

At stage 220, the emergency notification utility may determine whether automatic location tracking of the device (referred to herein as tracking) is enabled. Tracking may include periodically determining the device location and transmitting the device location to the server without additional user intervention. Tracking may be enabled by the user via the user interface (which may correspond to the user interface 117 described above). If the emergency notification utility determines that tracking is enabled, the process 200 may proceed to stage 225. Tracking may provide useful information to a search party looking for the user and/or the device and to the server so that it may determine what other devices, if any, are near the device. At stage 225, the emergency notification utility may determine the device location using the GPS module (which may correspond to the GPS module 114 described above) or any other suitable module. At stage 230, the emergency notification utility may transmit the device location to the server via the WWAN antenna.

If, however, the emergency notification utility determines that tracking is not enabled, the process 200 may proceed to stage 235. The user may be able to use other features of the emergency notification utility without tracking enabled. For example, the user may want to conserve battery power while viewing a history of where the device has been recently. The user may also desire privacy while using such other features. At stage 235, the emergency notification utility may determine whether the user has triggered an emergency notification. The emergency notification utility may do so by receiving specific input from the user via the user interface. For example, the user may provide this input by manually selecting emergency notification via the user interface, which the emergency notification utility may receive and process as the trigger. If the emergency notification utility determines that the user has not triggered the emergency notification, the process 200 may return to stage 220. If, however, the emergency notification utility determines that the user has triggered the emergency notification, the process 200 may proceed to stage 240.

At stage 240, the emergency notification utility may begin emergency notification. Emergency notification may include the emergency notification utility voice dialing an emergency contact on the device directly if the user selects the direct voice dial feature via the user interface. Alternatively or additionally, emergency notification may include the emergency notification utility performing stages 245 through 255. At stage 245, the emergency notification utility may transmit a request to the server for the server to transmit an emergency notification to other devices. The emergency notification may be a notification of an emergency that the user of the device may be experiencing or may have experienced, such as those described above or any other suitable situation. The emergency notification may take the form of a voice telephone call, a SMS, an e-mail, a push notification, and/or any other suitable communication. The emergency experienced by the user may include the user becoming lost or separated from a group, falling, getting injured, becoming ill, becoming involuntarily disabled (temporarily or permanently), fainting or otherwise becoming unconsciousness involuntarily, being trapped by inclement weather, and/or any other suitable experience. The device, the server, other devices, and/or other users may, but need not necessarily, infer what emergency the user is experiencing or has experienced based on the emergency notification. For example, it may be inferred that a user is immobilized based on an emergency notification triggered by a device location that has not changed sufficiently and/or an emergency notification including location data showing little or no movement.

The emergency notification may include information relating to the device, the user, and/or the nature of the emergency. For example, this information may include the device location; the time at which the most recent device location was received by the server; the weather near the device location at that time, at present, and/or in the near future; a characteristic of the user such as biometric characteristics including heart rate, blood pressure, body temperature, brain activity, and/or any other characteristic at that time and/or at present if supported by the device; the at least one criterion for automatic emergency notification used; the emergency the user is experiencing or has experienced (e.g., being lost, injured, trapped, etc.); and/or any other suitable information.

The other devices to which the server may transmit the emergency notification may include a local device near the device (which may correspond to the local device 180 described above) and/or any emergency contact device (which may correspond to the emergency contact device 190 described above) through which the emergency contact or contacts input by the user may receive a voice telephone call, a SMS, an e-mail, a push notification, and/or any other suitable communication.

The process 200 may then proceed to stage 250. At stage 250, the emergency notification utility may determine whether a WPAN beacon mode is enabled for the device. If the emergency notification utility determines that WPAN beacon mode is not enabled, the process 200 may end or restart. If, however, the emergency notification utility determines that WPAN beacon mode is enabled, the process 200 may proceed to stage 255. At stage 255, the emergency notification utility may transmit one or more WPAN beacons via the WPAN antenna (which may correspond to the WPAN antenna 115 described above). The process 200 may then end or restart. Detection of the WPAN beacon(s) may increase the probability that a local device will find the device and hopefully the user experiencing an emergency. The WPAN beacon may be a signal emitted via Bluetooth Low Energy, which may transmit information for longer intervals of time than other forms of communication given the same amount of battery power.

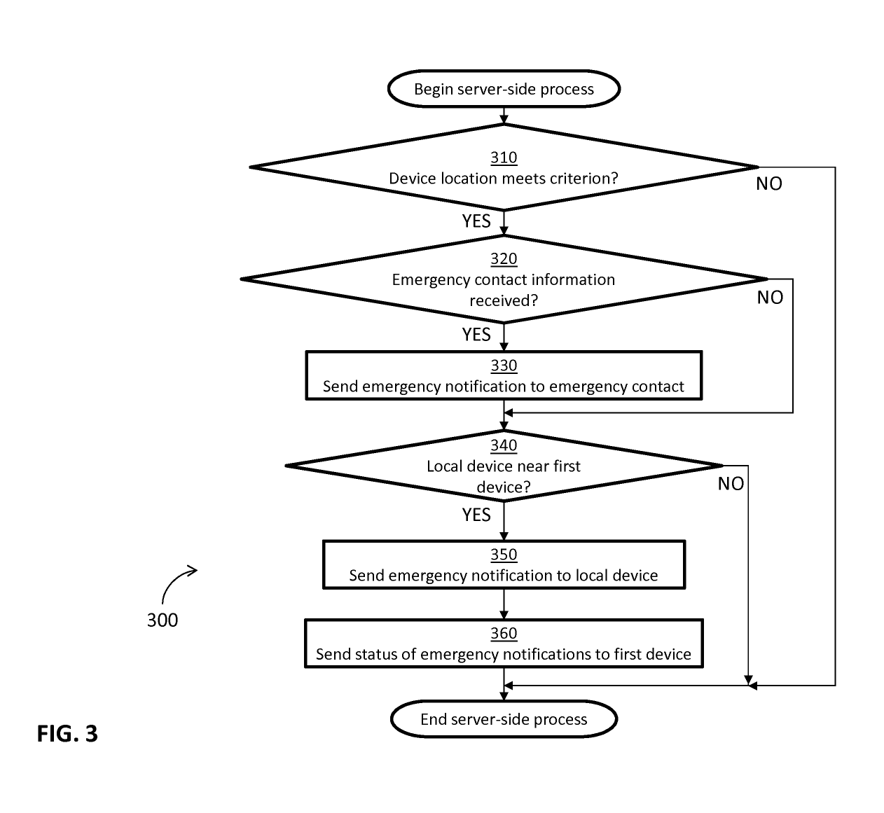

Referring now to FIG. 3, a flowchart of an exemplary server-side process 300 for automatically sending an emergency notification that may be used in some embodiments is illustrated therein. Before the process 300 begins, a server operator may install on a server (which may correspond to the server 160 described above) and configure a server utility through which embodiments of the present application may operate. The process 300 begins at stage 310. At stage 310, the server utility may determine whether a device location (and/or any other suitable information, such as biometric characteristics of the user) it has received from a first device (which may correspond to the device 110 described above) satisfies at least one criterion for automatic emergency notification (which may correspond to the criterion for automatic emergency notification 130 above) it previously received from the first device. The server utility may make this determination by comparing the device location, biometric characteristics of the user, and/or any other suitable information to the at least one criterion. If the server utility determines that the device location, biometric characteristics, and/or other suitable information does not satisfy the at least one criterion, the process 300 may end or restart. If, however, the server utility determines that the device location, biometric information, and/or other suitable information satisfies the at least one criterion, the process 300 may proceed to stage 320.

At stage 320, the server utility may determine whether it has received emergency contact information from the first device. If the server utility determines that it has received emergency contact information from the first device, the process 300 may proceed to stage 330. At stage 330, the server utility may transmit an emergency notification to one or more emergency contacts identified by the emergency contact information.

The emergency notification may be a notification of an emergency that the user of the first device may be experiencing or may have experienced, such as those described above or any other suitable situation. The emergency notification may take the form of a voice telephone call, a SMS, an e-mail, a push notification, and/or any other suitable communication. The emergency experienced by the user may include the user becoming lost or separated from a group, falling, getting injured, becoming ill, becoming involuntarily disabled (temporarily or permanently), fainting or otherwise becoming unconsciousness involuntarily, being trapped by inclement weather, and/or any other suitable experience.

The emergency notification may include information relating to the device, the user, and/or the nature of the emergency. For example, this information may include the device location; the time at which the most recent device location was received by the server; the weather near the device location at that time, at present, and/or in the near future; a characteristic of the user such as biometric characteristic including heart rate, blood pressure, body temperature, brain activity, and/or any other characteristic at that time and/or at present; the at least one criterion for automatic emergency notification used; the emergency the user is experiencing or has experienced (e.g., being lost, injured, trapped, etc.); and/or any other suitable information.

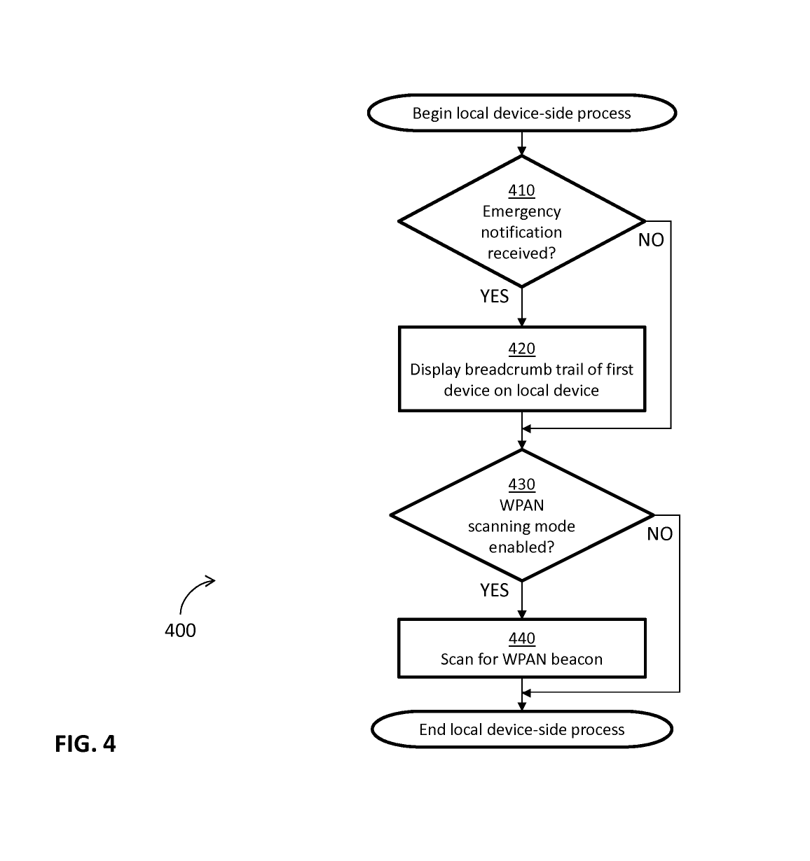

If, however, the server utility determines that it has not received emergency contact information from the first device, the process 300 may proceed to stage 340. At stage 340, the server utility may determine whether a local device (which may correspond to the local device 180 described above) is near the first device. For example, the server utility may determine that the local device is near the first device if the local device is within a range of the first device, such as within signal range or other threshold distance. The server utility may make this determination by receiving locations from one or more local devices and comparing those locations to the device location. For example, each local device may have a GPS or other location module, with which it can determine its own location (such as in the form of coordinates), and a WPAN antenna, with which it can transmit that location to the server utility. The server utility may receive these locations and compare them to the device location, such as by comparing their respective coordinates, in order to calculate the proximity of each local device. If a local device is not near the first device (e.g., not within a threshold distance), the process 300 may end or restart. If, however, a local device is near the first device, the process 300 may proceed to stage 350. At stage 350, the server utility may transmit an emergency notification to the local device. The emergency notification may be as described above in relation to FIG. 3, but it may also include a push notification to local device utility (described below in relation to FIG. 4). At stage 360, the server utility may transmit a status of the emergency notifications to the device. This status may relate to the transmission and/or reception of the emergency notifications transmitted by the server utility to the one or more emergency contacts and/or the local device. The status may be a push notification. The status may include information such as whether the emergency notifications were successfully sent and/or received. The status may also activate the WPAN beacon mode of the device if it is enabled and the user does not respond within a designated interval of time. Alternatively or additionally, the status may include information relating to whether the emergency notifications were triggered automatically or manually via the device. The process 300 may then end or restart.

FIG. 4 is a flowchart of an exemplary local process 400 for automatically sending an emergency notification that may be used in some embodiments. Before the process 400 begins, a local device user may install on the local device (which may correspond to the local device 180 described above) and configure a local device utility through which embodiments of the present application may operate. The process 400 begins at stage 410. At stage 410, the local device utility may determine whether an emergency notification has been received by the local device utility from a first device (which may correspond to the device 110 described above). The local device utility may make this determination by monitoring its external input for an emergency notification.

The emergency notification may be a notification of an emergency that the user of the first device may be experiencing or may have experienced, such as those described above or any other suitable situation. The emergency notification may take the form of a voice telephone call, a SMS, an e-mail, a push notification, and/or any other suitable communication. The emergency experienced by the user may include the user becoming lost or separated from a group, falling, getting injured, becoming ill, becoming involuntarily disabled (temporarily or permanently), fainting or otherwise becoming unconsciousness involuntarily, being trapped by inclement weather, and/or any other suitable experience.

The emergency notification may include information relating to the device, the user, and/or the nature of the emergency. For example, this information may include the device location; the time at which the most recent device location was received by the server; the weather near the device location at that time, at present, and/or in the near future; a characteristic of the user such as biometric information including heart rate, blood pressure, body temperature, brain activity, and/or any other characteristic at that time and/or at present if supported by the device; the at least one criterion for automatic emergency notification used; the emergency the user is experiencing or has experienced (e.g., being lost, injured, trapped, etc.); and/or any other suitable information.

If the local device utility determines that an emergency notification has been received by the local device utility, the process 400 may proceed to stage 420. At stage 420, the local device utility may display a breadcrumb trail of locations of the first device on the local device. The breadcrumb trail may represent the recent history of locations of the first device. The local device utility may display the breadcrumb trail as a map, with the locations of the first device marked with an indicator, icon, or any other suitable marking, or in any other suitable way. The breadcrumb trail may be used by a potential rescue party to see where the first device (and, in most situations, the user of the first device) has been and where it has been heading. The breadcrumb trail may be useful in locating the user in various situations, such as when no device location has been received recently. If, however, the local device utility determines that an emergency notification has not been received by the local device utility, the process 400 may proceed to stage 430.

At stage 430, the local device utility may determine whether a WPAN scanning mode is enabled for the local device. WPAN scanning mode may be a mode of operation of the local device and its WPAN antenna that scans for WPAN signals or beacons such as those transmitted via Bluetooth Low Energy. If the local device utility determines that WPAN scanning mode is not enabled, the process 400 may end or restart. If the local device utility determines that WPAN scanning mode is enabled, the process 400 may proceed to stage 440. At stage 440, the local device utility may scan for a WPAN beacon. Detection of the WPAN beacon by the local device may increase the probability that the local device will find the first device and hopefully the user experiencing an emergency. The WPAN beacon may be a signal emitted via Bluetooth Low Energy, which may transmit information for longer intervals of time than other forms of communication given the same amount of battery power. The process 400 may then end or restart.

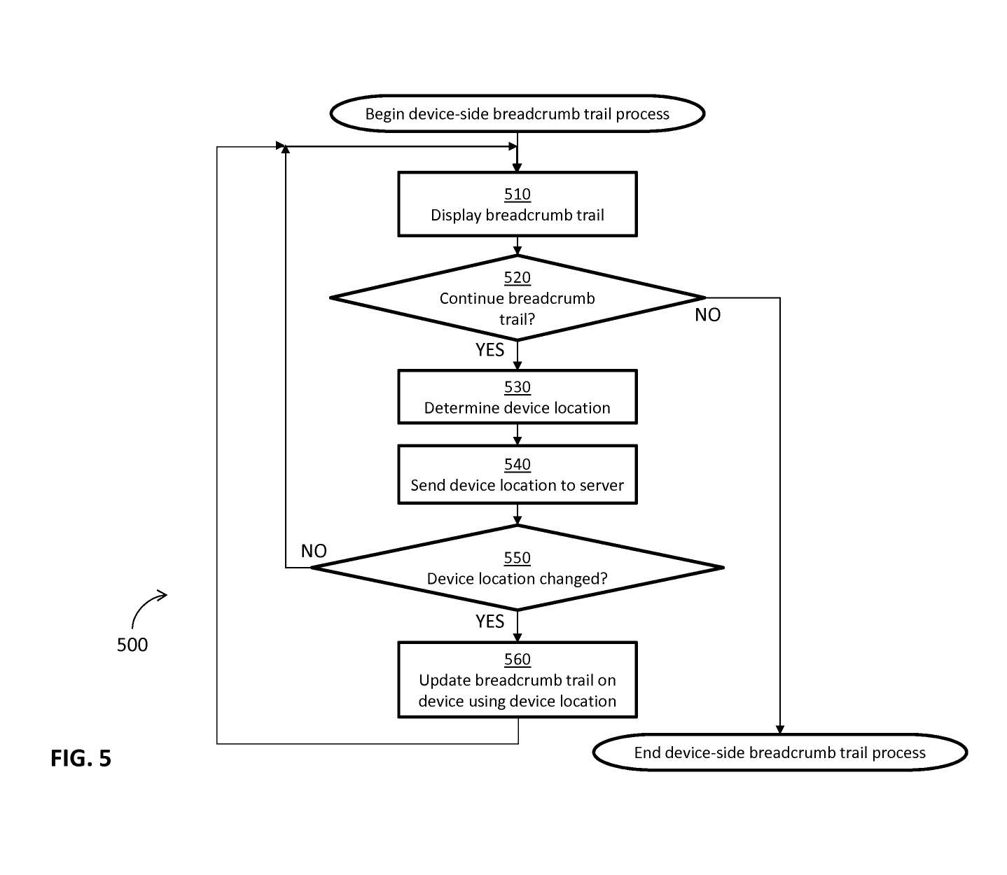

Referring now to FIG. 5, a flowchart of an exemplary breadcrumb trail process 500 for automatically sending an emergency notification that may be used in some embodiments is illustrated therein. Before the process 500 begins, a user may install on the device (which may correspond to the device 110 described above) and configure an emergency notification utility through which embodiments of the present application may operate. The process 500 begins at stage 510. At stage 510, the emergency notification utility may display a breadcrumb trail representing a recent history of device locations to the user. The user may use this breadcrumb trail to view where the device (and, in most situations, the user) has been and where it has been heading. The emergency notification utility may display the breadcrumb trail as a map, with the locations of the device marked with an indicator, icon, or any other suitable marking, or in any other suitable way.

At stage 520, the emergency notification utility may determine whether to continue the breadcrumb trail process 500. This determination may be made based on a user setting or any other suitable criteria. If the emergency notification utility determines not to continue the breadcrumb trail process 500, the process 500 may end. If the emergency notification utility determines to continue the breadcrumb trail process 500, the process 500 may proceed to stage 530. At stage 530, the emergency notification utility may determine the device location using the GPS module (which may correspond to the GPS module 114 describe above). At stage 540, the emergency notification utility may transmit the device location to a server (which may correspond to the server 160 described above, and which may also update a breadcrumb trail on the server). At stage 550, the emergency notification utility may determine whether the device location has changed. If emergency notification utility determines that the device location has not changed, the process 500 may return to stage 510. If the emergency notification utility determines that the device location has changed, the process 500 may proceed to stage 560. At stage 560, the emergency notification utility may update the breadcrumb trail on the device using the device location. The process 500 may then return to stage 510.

It should be appreciated that various operations are described in FIGS. 2-5. Some of these operations are common to more than one of the figures. To illustrate the generality of the approach described herein, similar operations may be described as being triggered or executed differently in connection with different ones of the figures. It should be appreciated that either the initiation or performance of an operation as described in connection with one of the figures may alternatively or additionally be used in connection with a similar operation illustrated in another figure.

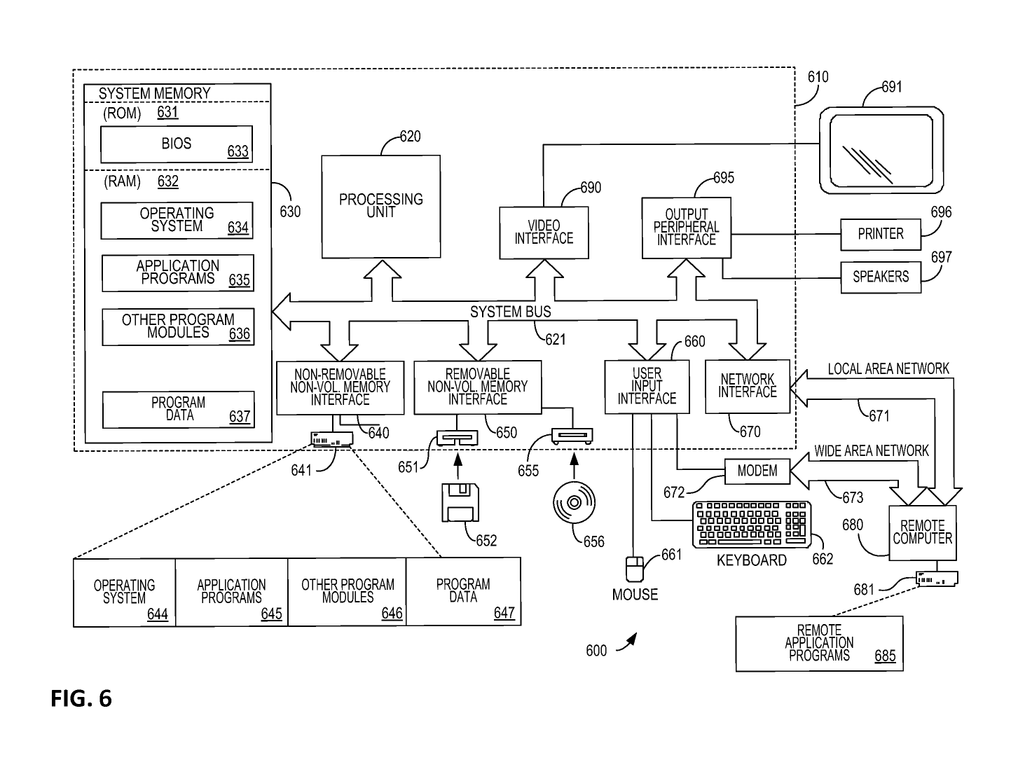

FIG. 6 illustrates an example of a suitable computing system environment 600 on which some embodiments may operate. The computing system environment 600 is only one example of a suitable computing environment and is not intended to suggest any limitation as to the scope of use or functionality of the application. Neither should the computing environment 600 be interpreted as having any dependency or requirement relating to any one or combination of components illustrated in the exemplary operating environment 600.

Embodiments of the application are operational with numerous other general purpose or special purpose computing system environments or configurations. Examples of well-known computing systems, environments, and/or configurations that may be suitable include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The application may also be practiced in distributed computing environments where tasks are performed by remote processing devices that are linked through a communications network. In a distributed computing environment, program modules may be located in both local and remote computer storage media including memory storage devices.

With reference to FIG. 6, an exemplary system for implementing embodiments of the application includes a general purpose computing device in the form of a computer 610. Computer 610, with programming or other modification to perform functions as described herein may be used to implement a first device, a local device, an emergency contact device, or a server 610. Though not shown in FIG. 6, such modifications may include modifications to include any functions attributed to PCB 170. Alternatively or additionally, device 610, rather than being dedicated to a particular task, may be a computer that would, in normal operation, store or retrieve information from a storage device. In that scenario, computer 610 may be a user's computer programmed to improve outdoor safety using techniques as described herein.

Components of computer 610 may include, but are not limited to, a processing unit 620, a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through an non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690. In addition to the monitor, computers may also include other peripheral output devices such as speakers 697 and printer 696, which may be connected through a output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

Having thus described several aspects of at least one embodiment of this application, it is to be appreciated that various alterations, modifications, and improvements will readily occur to those skilled in the art.

Such alterations, modifications, and improvements are intended to be part of this disclosure, and are intended to be within the spirit and scope of the application. Further, though advantages of the present application are indicated, it should be appreciated that not every embodiment will include every described advantage. Some embodiments may not implement any features described as advantageous herein and in some instances. Accordingly, the foregoing description and drawings are by way of example only.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the application may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the application discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present application as discussed above. As used herein, the term “computer-readable storage medium” encompasses only a computer-readable medium that can be considered to be a manufacture (i.e., article of manufacture) or a machine. Alternatively or additionally, the application may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present application as discussed above. Additionally, it should be appreciated that according to one aspect of this embodiment, one or more computer programs that when executed perform methods of the present application need not reside on a single computer or processor, but may be distributed in a modular fashion amongst a number of different computers or processors to implement various aspects of the present application.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present application may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the application may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. At least one computer-readable storage medium encoded with executable instructions that, when executed by a first device, cause the first device to carry out a method comprising:
in response to determining that tracking of a geographic location of the first device is enabled:
determining a geographic location of the first device; and
transmitting the geographic location of the first device to a second device; and
in response to determining that a criterion for automatic emergency notification is satisfied, transmitting a notification of an emergency for a user to a third device different from the second device.

2. The at least one computer-readable storage medium of claim 1, wherein transmitting the notification to the third device comprises in response to determining that the geographic location of the first device has not changed more than a threshold distance for a designated interval of time, transmitting the notification to the third device.

3. The at least one computer-readable storage medium of claim 1, wherein transmitting the notification to the third device comprises in response to determining that, within a designated interval of time or by a designated time, the geographic location of the first device has not been within a designated area, transmitting the notification to the third device.

4. The at least one computer-readable storage medium of claim 1, wherein transmitting the notification to the third device comprises in response to determining that one or more values of one or more biometric characteristics of the user is outside a designated range, transmitting the notification to the third device.

5. The at least one computer-readable storage medium of claim 1, wherein transmitting the notification to the third device comprises in response to
determining that a heart rate of the user is outside a first range and/or
determining that a body temperature of the user is outside a second range, transmitting the notification to the third device.

6. The at least one computer-readable storage medium of claim 1, wherein transmitting the notification to the third device comprises in response to determining that the user has input an emergency notification trigger, transmitting the notification to the third device.

7. The at least one computer-readable storage medium of claim 1, wherein:
the method further comprises:
receiving, via a user interface of the first device, the criterion from the user;
receiving, via the user interface of the first device, information for an emergency contact from the user, the emergency contact being a human; and
transmitting the information for the emergency contact to the second device; and
transmitting the notification to the third device comprises transmitting a request to the second device to transmit the notification to the third device, wherein the third device is a device associated with and/or operated by the emergency contact.

8. The at least one computer-readable storage medium of claim 1, wherein:
transmitting the notification to the third device comprises transmitting a request to the second device to transmit the notification to the third device.

9. The at least one computer-readable storage medium of claim 1, wherein:
transmitting the notification to the third device comprises transmitting a signal the third device is configured to detect.

10. The at least one computer-readable storage medium of claim 1, wherein:
transmitting the notification to the third device comprises transmitting a signal to a device that is within signal range of the first device.

11. The at least one computer-readable storage medium of claim 1, the method further comprising:
in response to determining that the tracking of the geographic location of the first device is enabled:
storing on the first device a history of geographic locations of the first device; and
displaying on the first device the history of geographic locations of the first device.

12. At least one computer-readable storage medium encoded with executable instructions that, when executed by at least one processor, cause the at least one processor to carry out a method comprising:
receiving, from a first device, a geographic location of the first device;
storing a history of geographic locations of the first device; and
in response to determining that a criterion for automatic emergency notification is satisfied, transmitting a notification of an emergency for a user of the first device to a second device.

13. The at least one computer-readable storage medium of claim 12, the method further comprising:
receiving, from the first device, the criterion; and
transmitting, for display on the second device, the history of geographic locations of the first device.

14. The at least one computer-readable storage medium of claim 12, the method further comprising:
receiving, from the first device, information for an emergency contact of the user, the emergency contact being a human; and
transmitting, to the first device, a status of the notification to the first device.

15. The at least one computer-readable storage medium of claim 12, the method further comprising:
receiving a geographic location of the second device; and
determining, based on the geographic location of the first device and the geographic location of the second device, whether the second device is within a designated range of the first device.

16. The at least one computer-readable storage medium of claim 12, wherein:
the method further comprises receiving, from the first device, one or more values of one or more biometric characteristics of the user; and
transmitting the notification to the second device comprises in response to determining that the one or more values of the one or more biometric characteristics of the user is outside a designated range, transmitting the notification to the second device.

17. The at least one computer-readable storage medium of claim 12, wherein:
the method further comprises receiving, from the first device, one or more values of one or more biometric characteristics of the user, and
transmitting the notification to the second device comprises in response to
determining that a heart rate of the user is outside a first range and/or
determining that a body temperature of the user is outside a second range, transmitting the notification to the second device.

18. At least one computer-readable storage medium encoded with executable instructions that, when executed by at least one processor, cause the at least one processor to carry out a method comprising:
receiving, from a first device and/or a second device, a notification of an emergency for a user of the first device; and
in response to receiving the notification:
displaying information about the first device and/or the user based on the notification; and
scanning for a signal from the first device.

19. The at least one computer-readable storage medium of claim 18, wherein:
the method further comprises receiving, from the first device and/or the second device, the information about the first device and/or the user, and
the information about the first device and/or the user comprises a history of geographic locations of the first device.

20. The at least one computer-readable storage medium of claim 18, wherein:
the method further comprises receiving, from the first device and/or the second device, the information about the first device and/or the user, and
the information about the first device and/or the user comprises one or more values of one or more biometric characteristics of the user.
